(19) United States
(12) Patent Application Publication
(10) Pub. No.: US 2013/0199569 A1
(43) Pub. Date: Aug. 8, 2013

(54) DETERGENT COMPOSITION COMPRISING MANGANESE-OXALATE

(71) Applicants: Marine Cabirol, Ludwigshafen (DE); Nicole Graf, Ludwigshafen (DE); Judith Preuschen, Ludwigshafen (DE)

(72) Inventors: Marine Cabirol, Ludwigshafen (DE); Nicole Graf, Ludwigshafen (DE); Judith Preuschen, Ludwigshafen (DE)

(73) Assignee: RECKITT BENCKISER N.V., WT HOOFDDORP (NL)

(21) Appl. No.: 13/818,468

(22) PCT Filed: Aug. 18, 2011
(86) PCT No.: PCT/GB11/51556

§ 371 Date: Apr. 17, 2013

(30) Foreign Application Priority Data
Aug. 27, 2010 (GB) 1014328.7

(51) Int. Cl. C11D 3/39; C11D 3/20; A47L 15/00; C11D 3/33

(52) U.S. Cl. CPC C11D 3/391; C11D 3/33; C11D 3/2082; A47L 15/0018
USPC 134/18; 510/224

(57) ABSTRACT

The present invention provides a detergent composition comprising MGDA, managanese oxalate and a bleach compound. In particular the invention provides detergent compositions that are suitable for automatic dishwashing (ADW).

### TECHNICAL FIELD

The invention relates to a detergent composition. In particular the invention relates to a detergent composition suitable for automatic machine dishwashing.

### BACKGROUND

Automatic dishwashing (ADW) detergents contain builders. These are complexing agents that help prevent soil deposition.

Typically the compounds used as builders are inorganic phosphates, for example, sodium tripolyphosphate (STPP).

Recent environmental considerations on the impact of phosphates in waste water make it desirable to replace these chemicals in ADW detergents. Phosphate builders have been connected with eutrophication issues.

Because of this, regulatory amendments are likely to be introduced in the near future leading to the prohibition of the use of phosphates, or at least to a reduction of the amount of phosphorous compounds allowed to be present in ADW detergent.

Therefore, in recent years there has been an ever increasing trend towards the development of alternative environmentally friendly complexing agents (builders), which may be used instead of predominantly phosphorous based builders.

The development of alternative builder systems has been complicated by the number of functions the phosphates provided to the compositions. Essentially this is four different functions:

(1) providing alkalinity;
(2) buffering capacity,
(3) complexing of magnesium and calcium ions; and
(4) dispersing capacity of calcium carbonate

Unfortunately, while many different alternative builders have been developed, all have faced cleaning performance problems in comparison with phosphates in the equivalent ADW compositions.

To overcome these deficiencies, manufacturers have been forced to modify their compositions to compensate for the different conditions afforded by the newer biodegradable builders.

A key area of cleaning performance of an ADW composition is its bleaching performance. The bleach performance depends on the bleach system and the pH of the wash liquor. These systems typically comprise a bleach compound, an activator and an oxidation catalyst.

It is the aim of the present invention to provide a phosphate free ADW composition with a superior cleaning performance. It is also the aim of the present invention to provide a detergent composition with a superior bleaching performance.

### STATEMENT OF INVENTION

The invention provides a detergent composition comprising an MGDA builder, a bleaching compound and manganese oxalate as an oxidation catalyst.

### DETAILED DESCRIPTION OF THE INVENTION

It has surprisingly been found that detergent formulations comprising the builder methyl-glycine-diacetic acid (MGDA) and salts thereof, in combination with manganese oxalate as a bleach activation catalyst provides increased bleaching performance when used in detergent compositions containing a bleach compound.

The detergent formulations of the present invention are particularly effective as ADW detergent compositions. Other uses of the detergent compositions may include fabric cleaning.

It has also been found that this performance is limited to the combination of MGDA and manganese oxalate. Manganese oxalate does not lead to an improved performance when used in combination with any other non phosphate or organic builder compound.

Without wishing to be bound by theory, it is suggested that the manganese oxalate and the MGDA interact to form a more active complex species for the oxidative catalysis of the bleach system/component.

The amount of MGDA used in the detergent compositions of the present invention may be between 5% and 95% by weight, preferably between 10% and 75% by weight, preferably between 15% and 60% and most preferably between 20% and 50% by weight of the composition.

The amount of manganese oxalate used in the detergent compositions of the present invention comprise between 0.005% and 5% by weight, preferably between 0.01% and 2.5% by weight, preferably between 0.05% and 1% by weight and most preferably between 0.1% and 0.5% by weight of the composition.

Any conventional bleaching compound can be used in any conventional amount in either the composition of the invention or in any other detergent composition forming part of the multi-phase unit dose detergent composition.

There may be more than one bleaching compound in the detergent compositions of the present invention. A combination of bleaching compounds can be used.

The bleaching compound is preferably present in the relevant composition in an amount of at least 1% by weight, more preferably at least 2% by weight, more preferably at least 4% weight. Preferably it is present in the relevant composition in an amount of up to 30% weight, more preferably up to 25% weight, and most preferably up to 20% by weight.

If more than one bleaching compound is used, the total fraction of bleaching compound is preferably present in the relevant composition in an amount of at least 1% by weight, more preferably at least 2% by weight, more preferably at least 4% weight. Preferably it is present in the relevant composition in an amount of up to 30% weight, more preferably up to 25% weight, and most preferably up to 20% by weight.

In the detergent compositions of the present invention the bleach compound normally depends on hydrogen peroxide or percarbonate as a hydrogen peroxide source.

Most preferably the bleach is selected from inorganic peroxy-compounds and organic or inorganic peracids and the salts derived therefrom.

Examples of inorganic perhydrates include perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life.

The preferred percarbonate is sodium percarbonate of the formula 2Na₂CO₃.3H₂O₂. A percarbonate, when present, is preferably used in a coated form to increase its stability.

Inorganic peracids include persulfates such as potassium peroxymonopersulfate (KMPS).

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

The pH of the detergent composition may be between 6 and 14, preferably between 8 and 12 and more preferably between 9 and 11.

### Optional Ingredients

In addition to the above, the detergent compositions of the present invention may further comprise one or more of the following optional ingredients.

### Builders

In addition to the builder MGDA or a salt thereof, the composition may further comprise one or more additional builder compounds. These may be selected, for example, from the group comprising sodium citrate, sodium iminodisuccinate, sodium hydroxyiminodisuccinate, and glutamic diacetic acid sodium salt or combinations thereof.

Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

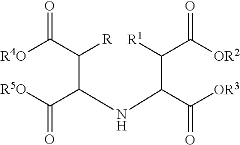

in which R, R¹, independently of one another, denote H or OH, R², R³, R⁴, R⁵, independently of one another, denote a cation, hydrogen, alkali metal ions and ammonium ions, ammonium ions having the general formula R⁶, R⁷, R⁸, R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

Preferably, the total builder quantity in the detergent composition comprises from 5% to 95% by weight, preferably from 15% to 75% by weight, preferably from 25% to 65% by weight, most preferably from 30% to 60% by weight of the detergent composition.

It is preferred to avoid phosphorous containing builders, or at least minimize the amount of these builders required. But ifphosphorous-containing builders are also to be used it is preferred that mono-phosphates, di-phosphates, tri-polyphosphates or oligomeric-poylphosphates are used. The alkali metal salts of these compounds are preferred, in particular the sodium salts. An especially preferred phosphate builder is sodium tripolyphosphate (STPP).

Most preferably the compositions of the present invention are completely phosphate free compositions.

### Oxidation Catalysts

In addition to the Manganese oxalate, the compositions of the invention may also include further oxidation catalysts.

Some non limiting examples of other oxidation catalysts that may be used in the compositions of the present invention include manganese-(II)-acetate, manganese-(II)-collagen, cobalt-amine catalysts and the Manganese-triazacyclononane (TACN) catalyst. (Bis(N,N,N-trimethyl-1,4,7-triazacyclononane)-trioxo dimanganese(IV) (hexafluorophosphate))

The skilled person will be aware of other oxidation catalysts that may be successfully combined with the detergent compositions of the present invention.

### Surfactants

Surfactants can form key components of detergent compositions. There are four main classes of surfactants are anionic, cationic, amphoteric and non-ionic.

Non-ionic surfactants are preferred for automatic dishwashing (ADW) detergents since they are defined as low foaming surfactants. The standard non-ionic surfactant structure is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO).

The length of the fatty alcohol and the degree of ethoxylation and/or propxylation determines if the surfactant structure has a melting point below room temperature or in other words if it is a liquid or a solid at room temperature.

Surfactants may also comprise butylene oxide units (BO) as a result of butoxylation of the fatty alcohol. Preferably, this will be a mix with PO and EO units. The surfactant chain can be terminated with a butyl (Bu) moiety.

Preferred solid non-ionic surfactants are ethoxylated non-ionic surfactants prepared by the reaction of a mono-hydroxy alkanol or alkylphenol with 6 to 20 carbon atoms. Preferably the surfactants have at least 12 moles, particularly preferred at least 16 moles, and still more preferred at least 20 moles, such as at least 25 moles of ethylene oxide per mole of alcohol or alkylphenol.

Particularly preferred solid non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

The non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols which additionally comprise poly-oxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and poly-oxypropylene and block copolymers of polyoxyethylene and polyoxypropylene initiated with trimethylolpropane.

Another preferred class of non-ionic surfactant can be described by the formula:

R₁O[CH₂CH(CH₃)O]ₓ[CH₂CH₂O]_{y}[CH₂CH(OH)R₂]

where R₁ represents a linear or branched chain aliphatic hydrocarbon group with 4-18 carbon atoms or mixtures thereof, R₂ represents a linear or branched chain aliphatic hydrocarbon rest with 2-26 carbon atoms or mixtures thereof, x is a value between 0.5 and 1.5 and y is a value of at least 15.

Another group of preferred non-ionic surfactants are the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃=H, methyl or ethyl are particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃=H) or propylene oxide (R₃=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

In a particularly preferred embodiment of the present invention, the composition according to the first aspect of the present invention is one wherein the liquid non-ionic surfactant has the general formula

R₁-[EO]ₙ-[PO]ₘ—[BO]ₚ-Bu_{q}

wherein:
R₁ is an alkyl group of between C₈ and C₂₀;
EO is ethylene oxide;
PO is propylene oxide;
BO is butylene oxide;
Bu is butylene
n and m are integers from 0 to 15;
p is an integer from 0 to 15; and
q is 0 or 1.

Examples of especially preferred nonionic surfactants are the Plurafac™, Lutensol™ and Pluronic™ range from BASF and Genapol™ series from Clariant.

The total amount of surfactants typically included in the detergent compositions is in amounts of up to 15% by weight, preferably of from 0.5% to 10% by weight and most preferably from 1% to 5% by weight.

Preferably non-ionic surfactants are present in the compositions of the invention in an amount of from 0.1% to 5% by weight, more preferably 0.25% to 3% by weight and most preferably 0.5% to 2.5% by weight.

### Bleach Activators

Generally the use of a bleach activator in a detergent composition leads to a significant reduction in the effective washing temperature. Compositions of the present invention may also comprise a bleach activator.

If desired therefore, the detergent compositions may comprise one or more additional bleach activators depending upon the nature of the bleaching compound.

Any suitable bleach activator or combination of bleach activators may be included. A non-limiting example of a bleach activator is tetra acetyl-ethylenediamine (TAED).

Conventional amounts of the bleach activators may be used e.g. in amounts of from 1% to 30% by weight, more preferred of from 2% to 25% by weight and most preferred of from 3% to 15% by weight of the detergent composition.

### Polymers, Including Sulphonated Polymers

Polymers intended to improve the cleaning performance of the detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

### Enzymes

The composition may comprise one or more enzymes. Desirably the enzyme is present in the compositions in an amount of from 0.01% to 5% by weight especially 0.01% to 4% by weight, for each type of enzyme when added as a commercial preparation. As they are not 100% active preparations this represents an equivalent amount of 0.005% to 1% by weight of pure enzyme, preferably 0.01% to 0.75% by weight, especially 0.01% to 0.5% by weight of each enzyme used in the compositions. The total amount of enzyme in the detergent composition is preferably in the range of from 0.01% to 6% weight percent, especially 0.01% to 3% by weight, which represents an equivalent amount of 0.01% to 2% by weight of pure enzyme, preferably 0.02% to 1.5% by weight, especially 0.02% to 1% by weight of the total active enzyme used in the compositions.

Any type of enzyme conventionally used in detergent compositions may be used according to the present invention. It is preferred that the enzyme is selected from proteases, lipases, amylases, cellulases, pectinases, laccases, catalases and all oxidases or combinations thereof, with proteases and amylases being preferred. Any suitable species of these enzymes may be used as desired.

It is most preferred that protease and amylase enzymes are included in the compositions according to the invention. Such enzymes are especially effective for example in dishwashing detergent compositions

### Anti Corrosion Agents

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole TTA.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃.

Any suitable source of multivalent ions may be used, with the source preferably being chosen from sulphates, carbonates, acetates, gluconates and metal-protein compounds. Zinc salts are specially preferred glass corrosion inhibitors.

Any conventional amount of the anti-corrosion agents may be included in the compositions of the invention. However, it is preferred that they are present in an total amount of from 0.01% to 5% by weight, preferably 0.05% to 3% by weight, more preferably 0.1% to 2.5% by weight, such as 0.1% to 1% by weight based on the total weight of the composition. If more than one anti-corrosion agent is used, the individual amounts may be within the preceding amounts given but the preferred total amounts still apply.

### Format of the Composition

The detergent composition may take any form known in the art. Possible forms include tablets, powders, gels, pastes and liquids. The detergent compositions may also comprise a mixture of two or more forms. For example the composition may comprise a gel component and a free powder component.

Tablets may be homogeneous of composed of multi-layers. If the tablets are multi-layered then different layers may comprise different parts of the detergent composition. This may be done to increase stability or increase performance, or both.

The detergent compositions may be housed in PVOH rigid capsules or film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The invention is further demonstrated by the following non limiting examples. Further examples within the scope of the invention will be apparent to the person skilled in the art.

### Experimental Results

Two different detergent formulation formats were tested for improved bleaching performance˜Tablets and PVOH capsules.

### Example 1

### Tablets

Four bilayer compressed detergent tablets were prepared to demonstrate the present invention, Formulations A, B, C and D.

Tablet C is an example of a detergent composition of the present invention. Tablets A, B and D are comparative compositions only and are not detergent compositions that form part of the present invention.

The overall composition of the tablets is given in the table below.

| Component % by weight | A | B | C | D |
|---|---|---|---|---|
| Sodium carbonate | 12.8 | 12.9 | 29.9 | 30 |
| Sodium percarbonate | 16 | 16 | 16 | 16 |
| Methylglycine diacetic acid-Na MGDA | — | — | 30 | 30 |
| TAED | 5 | 5 | 5 | 5 |
| Protease | 1.3 | 1.3 | 1 | 1 |
| Amylase | 1.3 | 1.3 | 0.5 | 0.5 |
| Sulfonated co-polymer | 7 | 7 | 7 | 7 |
| Manganese oxalate | 0.1 | — | 0.1 | — |
| PEG 1500 | 3 | 3 | 3 | 3 |
| PEG 6000 | 3 | 3 | 3 | 3 |
| Citrate | 46 | 46 | — | — |
| C₁₆-C₁₈ Fattyalcohol Ethoxylate | 4 | 4 | 4 | 4 |
| HEDP | 0.5 | 0.5 | 0.5 | 0.5 |
| Total: | 100 | 100 | 100 | 100 |
| pH (1% by weight solution in water) | 10 | 10 | 10.3 | 10.3 |

Total tablet weight = 21 g

### Preparation of the Tablets:

The tablets are pressed out of two powders. The two powders used per tablet are indicated below.

### For Tablet A

Powder 1

(⅔ of the tab): Percarbonate, HEDP and part of the: Sodium Carbonate, Citrate, Sulfonated Polymer, PEG 1500, PEG 6000, C16-C18 Fattyalcohol Ethoxylate.

Powder 2

(⅓ of the tab): TAED, Amylase, Protease, Manganese Oxalate and part of the: Sodium Carbonate, Citrate, Sulfonated Polymer, PEG 1500, PEG 6000, Citrate, C₁₆-C₁₈ Fattyalcohol Ethoxylate

### For Tablet B

Powder 1

(⅔ of the tab): Percarbonate, HEDP and part of the: Sodium Carbonate, Citrate, Sulfonated Polymer, PEG 1500, PEG 6000, C16-C18 Fattyalcohol Ethoxylate,

Powder 2

(⅓ of the tab): TAED, Amylase, Protease, and part of the: Sodium Carbonate, Citrate, Sulfonated Polymer, PEG 1500, PEG 6000, Citrate, C₁₆-C₁₈ Fattyalcohol Ethoxylate

### For Tablet C

Powder 1

(⅔ of the tab): Percarbonate, HEDP and part of the: Sodium Carbonate, MGDA, Sulfonated Polymer, PEG 1500, PEG 6000, C16-C18 Fattyalcohol Ethoxylate,

Powder 2

(⅓ of the tab): TAED, Amylase, Protease, Manganese Oxalate and part of the: Sodium Carbonate, MGDA, Sulfonated Polymer, PEG 1500, PEG 6000, C₁₆-C₁₈ Fattyalcohol Ethoxylate

### For Tablet D

Powder 1

(⅔ of the tab): Percarbonate, HEDP and part of the: Sodium Carbonate, MGDA, Sulfonated Polymer, PEG 1500, PEG 6000, C16-C18 Fattyalcohol Ethoxylate,

Powder 2

(⅓ of the tab): TAED, Amylase, Protease, and part of the: Sodium Carbonate, MGDA, Sulfonated Polymer, PEG 1500, PEG 6000, C₁₆-C₁₈ Fattyalcohol Ethoxylate

### Method of Preparation of the Tablets

The two powders are compressed to form a two layer tablet. First powder 1 is compressed with pressure and then powder 2 is placed on top and then both are compressed together with further pressure. The two layers only have contact with each other at their interface which enables good stability properties for the tab. This allows components which could react with each other are to the greatest possible extent separated from each other.

### Example 2

### PVOH Capsules

Three PVOH injection moulded tablets with three compartments were also prepared to demonstrate the present invention. The compositions are described in the table below.

Capsule 1 is a comparative detergent composition, Capsules 2 and 3 are detergent compositions of the present invention.

The difference between the two capsules of the present invention is the location of the manganese-oxalate within the composition in the capsule. In capsule 2 the manganese-oxalate is located in the gel portion/compartment of the composition. In capsule 3, the managanse-oxalate is located in the second powder portion/compartment of the composition.

| PVOH | | | | |
|---|---|---|---|---|
| Capsule | Component % by weight | 1 | 2 | 3 |
| Powder 1 | Sodium carbonate | 8 | 8 | 8 |
| | Sodium percarbonate | 15 | 15 | 15 |
| | Methylglycine diacetic acid-Na | 45 | 45 | 45 |
| | MGDA | | | |
| Powder 2 | TAED | 5 | 5 | 5 |
| | Protease | 1 | 1 | 1 |
| | Amylase | 0.5 | 0.5 | 0.5 |
| | Sulfonated co-polymer | 8 | 8 | 8 |
| | Manganese oxalate | 0 | 0 | 0.5 |
| Gel portion | Manganese oxalate | 0.0 | 0.5 | 0 |
| | Surfactant (C₁₂—C₁₅—EO₈—PO₄), | 5 | 5 | 5 |
| | liquid | | | |
| | Citrate | 10.5 | 10 | 10 |
| | PEG 6000 as thickener | 1.5 | 1.5 | 1.5 |
| | Statistical EO-PO as | 0.5 | 0.5 | 0.5 |
| | thickener | | | |
| | Total | 100.0 | 100.0 | 100.0 |
| | pH (1% by weight solution in water) | 10.2 | 10.2 | 10.2 |

Capsule Fraction weights:
Powder 1: 6.5 g
Powder 2: 5.0 g
Gel: 3.0 g
PVOH Capsule: 2.5 g

### Processing of the Powders:

Powder 1: sodium carbonate, sodium percarbonate, MGDA are mixed together in the concentrations described above.

Powder 2: TAED, Protease granules, Amylase granules and the sulfonated copolymer are mixed together in the concentrations described above.

### Processing of the Gel:

The liquid surfactant is mixed with the PEG 6000 and Sodium Citrate in an Ystral X50/10 mixer at room temperature for 20 min with 1000 revs/minute until it yields a fine dispersion of solids and liquids. This dispersion does not show any phase separation over time.

The capsule is sealed with a PVOH film from Monosol PT 75. The capsule weight is 2.5 g. After adding the active ingredients equal to 14.5 g the capsule weight in total is 17 g.

### Bleaching Performance Testing

The bleach performance of the formulations was tested in a Miele 651 SC dishwashing machine using the 50° C. program following the IKW method. In each case a capsule with 17 g (or a tablet of 21 g) was added into the dosing chamber of the dishwasher. The water hardness was 21° GH. This test is repeated 4 times to produce averaged results. The results of bleach performance assess on the tea cups expressed on a scale of 1 to 10 (1 being worst and 10 being best).

### Results

### Tablet Bleach Scores:

| Formulation | A | B | C | D |
|---|---|---|---|---|
| Bleach Score | 3.6 | 3.2 | 6.0 | 4.3 |

The results for the four tablets clearly show that the composition containing both manganese-oxalate and MGDA (tablet C) provides an improved bleaching performance in comparison with citrate builder tablets A, B and MGDA only tablet D.

The combination of citrate with manganese-oxalate (tablet A) shows very little improvement over the citrate composition alone (tablet B). This is in contrast to the improvement shown with MGDA, tablets C and D. This shows that there is no synergy between the citrate and the Manganese oxalate and that Manganese-oxalate performance depends on the builder system used.

### PVOH Capsules Bleach Scores:

| Formulation | 1 | 2 | 3 |
|---|---|---|---|
| Bleach Score | 4.0 | 5.0 | 6.0 |

The capsule formulations of the present invention also show that the bleach performance is increased with the addition of manganese-oxalate to compositions comprising MGDA as a builder (Capsules 2 and 3).

Interestingly the manganese-oxalate performs better when it is mixed in Powder 2 rather than in the gel portion of the composition as demonstrated by the improved performance of formulation 3 over that of formulation 2.

Formulations 2 and 3 do not show any brown spots (formation of manganese dioxide MnO₂) after 3 months storage at 40° C. and 75% relative humidity. This demonstrates that manganese-oxalate is highly stable in the neutral and alkaline detergent compositions.

1. A detergent composition comprising manganese oxalate, MGDA and a bleach compound wherein the composition is encapsulated in a rigid PVOH capsule with one or more compartments.

2. A detergent composition according to claim 1, wherein the bleach compound comprises an inorganic perhydrate.

3. A detergent composition according to claim 2 wherein the inorganic perhydrate is percarbonate.

4. A detergent composition according to claim 1 wherein the composition further comprises at least one enzyme.

5. A detergent composition according to claim 4 wherein the at least one enzyme is selected from the group consisting of proteases and amylases.

6. A detergent composition according claim 1 wherein the composition further comprises at least one surfactant.

7. A detergent composition according to claim 1 wherein the composition further comprises an anti-corrosion agent.

8. A detergent composition according to claim 7 wherein the anti-corrosion agent comprises tolyltriazole (TTA).

9. A detergent composition according to claim 1 wherein the pH is between 8 and 14.

10. A detergent composition according to claim 1 wherein the composition comprises a bleach activator.

11. A detergent composition according to claim 1 wherein the composition further comprises a sulphonated polymer.

12. An ADW detergent composition according to claim 1

13. A detergent composition according to claim 1, wherein the detergent composition is in the form of: a powder, a gel, a liquid, a paste or any combination thereof.

14. A method of cleaning tableware comprising the steps of: cleaning the tableware in an automatic dishwashing process by contacting the table with the composition according to claim 1.

15. A detergent composition according to claim 10, wherein the bleach activator is tetraacetylethylenediamine (TAED).

16. An ADW detergent composition according to claim 12 which further excludes phosphate compounds in the ADW detergent composition.

17. An ADW detergent composition according to claim 1, wherien the detergent composition comprises a percarbonate as a bleach compound, at least one enzyme, at least one surfactant, an anti-corrosion agent, a bleach activator and a sulphonated polymer.
